(19) United States
(12) Patent Application Publication
(10) Pub. No.: US 2023/0076706 A1
(43) Pub. Date: Mar. 9, 2023

(54) INFORMATION PROCESSING APPARATUS, METHOD OF DETERMINING WEARING STATE, AND STORAGE MEDIUM

(71) Applicant: CASIO COMPUTER CO., LTD., Tokyo (JP)

(72) Inventors: Takeshi MIYAKE, Tokyo (JP); Keiichi NOMURA, Tokyo (JP)

(73) Assignee: CASIO COMPUTER CO., LTD., Tokyo (JP)

(21) Appl. No.: 17/900,320

(22) Filed: Aug. 31, 2022

(30) Foreign Application Priority Data
Sep. 7, 2021 (JP) 2021-145272

(51) Int. Cl. G04G 21/02

(52) U.S. Cl. CPC G04G 21/025

(57) ABSTRACT

An information processing apparatus includes a processor that periodically acquires output values from a sensor in a state where the sensor is worn adjacent to a body of a user via a wearable device, derives amplitude parameters representing amplitudes of a plurality of output values among the output values acquired from the sensor, the plurality of output values having been acquired at a plurality of different timings within a preset determination period, counts the number of amplitude parameters that are larger than a criterial value, among the derived amplitude parameters each representing a respective one of a plurality of amplitudes generated at different timings, the number being defined as an amplitude count for determination, and determines whether the wearable device is properly worn on the body of the user based on the amplitude count for determination.

This application is based on and claims the benefit of priority from Japanese Patent Application No. 2021-145272, filed on 7 Sep. 2021, the content of which is incorporated herein by reference.

### BACKGROUND OF THE INVENTION

The present invention relates to an information processing apparatus, a program, and a method of determining a wearing state.

### RELATED ART

Conventionally, there has been known a technique for determining a wearing state of a wearable device worn on or adjacent to the body of a user. Japanese Patent Application, Publication No. 2009-153832 discloses a pulse wave measurement apparatus that determines whether a pulse wave sensor is properly worn on a finger as a measurement site, based on a period of time which is equal to or loner than a predetermined time and during which an output of a light receiving element is continuously lower or higher than a predetermined threshold value.

### SUMMARY OF THE INVENTION

According to an aspect of the present invention, the information processing apparatus includes a processor that periodically acquires output values from a sensor in a state where the sensor is worn adjacent to a body of a user via a wearable device, derives amplitude parameters representing amplitudes of a plurality of output values among the output values acquired from the sensor, the plurality of output values having been acquired at a plurality of different timings within a preset determination period, counts the number of amplitude parameters that are larger than a criterial value, among the derived amplitude parameters each representing a respective one of a plurality of amplitudes generated at different timings, the number being defined as an amplitude count for determination, and determines whether the wearable device is properly worn on the body of the user based on the amplitude count for determination.

### BRIEF DESCRIPTION OF THE SEVERAL VIEWS OF THE DRAWING

FIG. 1 is a diagram illustrating an external structure of a wearable terminal according to an embodiment of the present invention;

FIG. 2 is a block diagram illustrating a hardware configuration of the wearable terminal according to the embodiment of the present invention;

FIG. 3 is a functional block diagram illustrating part of a functional configuration of the wearable terminal according to the embodiment of the present invention;

FIG. 4 is a flowchart illustrating an example of a flow of a wearing state determination process performed by the wearable terminal according to the embodiment of the present invention;

FIG. 5 is a graph illustrating measurement results of output values of a proximity sensor in a case where the wearable terminal is worn in a first wearing state;

FIG. 6 is a graph illustrating measurement results of output values of the proximity sensor in a case where the wearable terminal is worn in a second wearing state;

FIG. 7 is a graph illustrating measurement results of output values of the proximity sensor in a case where the wearable terminal is worn in a third wearing state;

FIG. 8 is a graph illustrating measurement results of a pulse rate measured by the wearable terminal worn in the first wearing state and a pulse rate measured by a chest belt;

FIG. 9 is a graph illustrating measurement results of a pulse rate measured by the wearable terminal worn in the second wearing state and a pulse rate measured by the chest belt; and

FIG. 10 is a graph illustrating measurement results of a pulse rate measured by the wearable terminal worn in the third wearing state and a pulse rate measured by the chest belt.

### DETAILED DESCRIPTION OF THE INVENTION

Embodiments of the present invention will be described with reference to the drawings.

Wearable Terminal

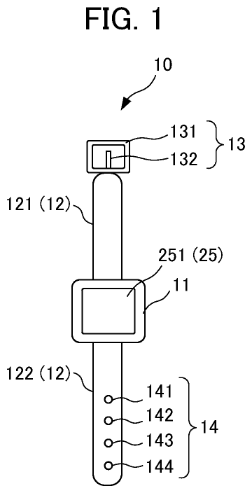

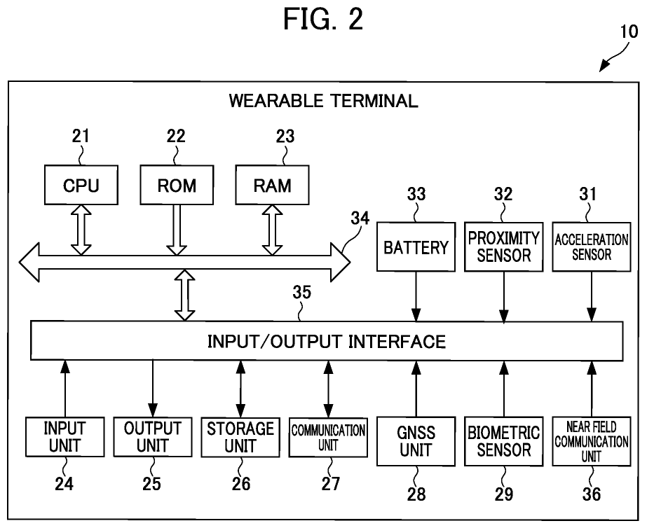

A wearable terminal 10 according to an embodiment of the present invention will be described. FIG. 1 is a diagram illustrating an external structure of the wearable terminal 10. FIG. 2 is a block diagram illustrating a hardware configuration of the wearable terminal 10.

The wearable terminal 10 is a wearable device that has an information processing function and is configured to be worn on or adjacent to the body of a user. The wearable terminal 10 according to the present embodiment is a smart watch that is configured to be worn on a wrist of a user and has a function of determining a wearing state thereof and a function of measuring biometric information such as a pulse wave of the user. The wearable terminal 10 is paired with a computer such as a smartphone or a tablet owned by the user (hereinafter, referred to as a user terminal), and transmits and receives various types of information.

The external structure of the wearable terminal 10 is now described. As illustrated in FIG. 1, the wearable terminal 10 includes a main body 11, a band 12 attached to the main body 11, and a display 251 forming part of an output unit 25 and configured to display an image.

The band 12 includes a first band 121 attached to one end of the main body 11, and a second band 122 attached to another end of the main body 11 opposite to the one end with the first band 121 attached.

The first band 121 has a buckle 13 attached to an end portion thereof opposite to the end attached to the main body 11. The buckle 13 has a buckle frame 131 and a buckle tongue 132. The second band 122 has a plurality of adjustment holes 14 into which the buckle tongue 132 is fitted. Specifically, the second band 122 has adjustment holes 141, 142, 143, and 144 that are aligned in the direction in which the second band 122 extends.

Next, the hardware configuration of the wearable terminal 10 will be described. As illustrated in FIG. 2, the wearable terminal 10 is a computer including a central processing unit (CPU) 21 as at least one processor, a read only memory (ROM) 22 as at least one memory, a random access memory (RAM) 23, an input unit 24, the output unit 25, a storage unit 26, a communication unit 27, a GNSS unit 28, a biometric sensor 29, an acceleration sensor 31, a proximity sensor 32, a battery 33, a bus 34, an input/output interface 35, and a near field communication unit 36.

The CPU 21, the ROM 22, and the RAM 23 are connected to one another via the bus 34. The CPU 21 executes various processes in accordance with programs stored in the ROM 22 or programs loaded to the RAM 23. The RAM 23 stores, as appropriate, data and the like that are necessary for the CPU 21 to execute the various processes.

The bus 34 is also connected to the input/output interface 35. The input/output interface 35 is connected to, in addition to the bus 34, the battery 33, the input unit 24, the output unit 25, the storage unit 26, the communication unit 27, the GNSS unit 28, the biometric sensor 29, the acceleration sensor 31, the proximity sensor 32, and the near field communication unit 36.

The battery 33 supplies power to the wearable terminal 10. For example, the battery 33 is constituted by a lithium-ion battery.

The input unit 24 and the output unit 25 are user interfaces electrically connected to the input/output interface 35 by wire or wirelessly. The input unit 24 includes buttons and the display 251. The output unit 25 includes, for example, the display 251, a speaker (not shown) for emitting sound, a vibration motor (not shown) for generating vibration. The display 251 is constituted by, for example, a liquid crystal display (LCD) or an organic electro-luminescent (EL) display, and a touch panel for detecting a position of touch by the user is provided on an image display surface of the display 251. The user can input information by touching the image display surface of the display 251.

The storage unit 26 includes a semiconductor memory such as dynamic random access memory (DRAM), and stores various data for the wearable terminal 10.

The communication unit 27 is a first wireless communication unit for an Internet line via which the CPU 21 is connected to a network such as the Internet.

The GNSS unit 28 is a positioning information acquisition unit for acquiring position information. GNSS is an abbreviation of Global Navigation Satellite System, and the GNSS unit 28 uses a satellite positioning system such as GPS. The GNSS unit 28 includes an antenna, receives positioning satellite signals transmitted from a plurality of positioning satellites, and transmits the received positioning satellite signals to the CPU 21. The CPU 21 pinpoints the position of itself, based on the positioning satellite signals received from the GNSS unit 28.

The biometric sensor 29 is a device for detecting biometric information regarding the user. An example of the biometric information detected by the biometric sensor 29 is pulse wave information regarding a pulse wave of the user.

The biometric sensor 29 of the present embodiment is disposed adjacent to the back surface of the main body 11 of the wearable terminal 10 (i.e., the surface that is in contact with the wrist of the user in a state where the user has the wearable terminal 10 worn thereon). The biometric sensor 29 is, for example, an optical sensor or a current detection type sensor functioning based on a current.

In the case where the biometric sensor 29 is of the optical type, it detects the pulse wave of the user by, for example, irradiating the skin of the user with light and measuring the reflected light in a state where the user has the wearable terminal 10 worn thereon. The light emitted by the biometric sensor 29 may be, for example, visible light or infrared light. Among them, green visible light is more preferable from the viewpoint of measurement accuracy of the pulse wave.

In the case where the biometric sensor 29 is of the current detection type, it acquires biometric information by directly detecting a weak current of the skin of the user, or by using a bioimpedance method according to which a pulse wave is measured by passing a weak current through the skin. For example, the biometric sensor 29 may start an operation for acquiring the biometric information in response to an operation by the user, or when it is determined that the user is doing exercise based on body movement information of the user acquired by the acceleration sensor 31.

The acceleration sensor 31 is a device that detects a movement in an arbitrary direction and an acceleration. For example, the acceleration sensor 31 is a three-axis sensor of a capacitance type or a piezoresistive element type, and detects accelerations generated in three axial directions that are orthogonal to one another. The acceleration sensor 31 can acquire body movement information of the user having the wearable terminal 10 worn thereon.

The proximity sensor 32 is disposed adjacent to the back surface of the main body 11 of the wearable terminal 10 (i.e., the surface that is in contact with the wrist of the user in a state where the user has the wearable terminal 10 worn thereon). The proximity sensor 32 is an optical sensor having a light emitter and a light receiver. An example of the optical sensor is a sensor that irradiates an object with irradiation light such as infrared light or visible light from the light emitter, and that receives, with the light receiver, reflected light originating from the irradiation light and reflected from the object. The proximity sensor 32 according to the present embodiment is an infrared sensor that irradiates the skin of the user with infrared light emitted from the light emitter in a state where the user has the wearable terminal 10 worn thereon. The irradiated infrared light is reflected from the skin of the user, and light including the reflected light (and external light other than the reflected light) is incident on the light receiver of the proximity sensor 32. In the proximity sensor 32, the light receiver measures the light incident thereon, and an output value corresponding to the measured incident light is outputted in a wave shape. When the wearable terminal 10 (the main body 11) is moved relative to the wrist of the user due to, for example, a body movement of the user, a change is caused in the incident light (including external light) on the light receiver in response to the relative movement, thereby varying the amplitude of the output value from the proximity sensor 32. In this case, as the relative movement of the wearable terminal 10 with respect to the wrist of the user increases, the amplitude of the output value from the proximity sensor 32 increases.

The near field communication unit 36 is a second wireless communication unit that communicates with the user terminal. The near field communication unit 36 includes an antenna, and communicates with the user terminal by a communication method based on, for example, a communication standard such as BLE (Bluetooth® Low Energy) or Wi-Fi (Wireless Fidelity).

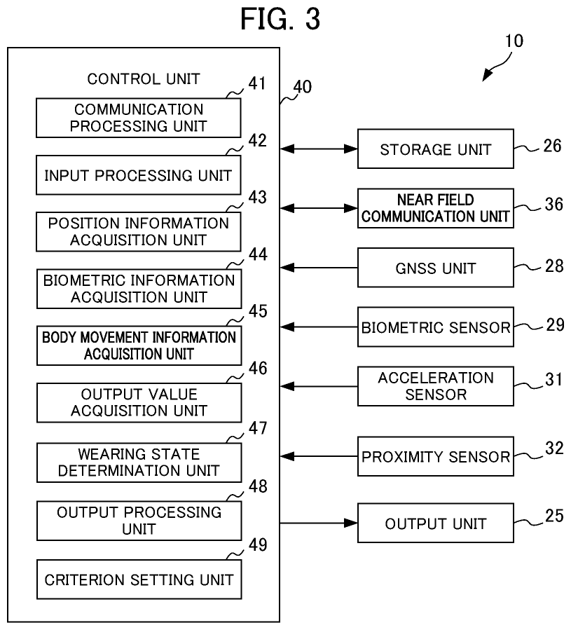

Next, a functional configuration of the wearable terminal 10 will be described. FIG. 3 is a functional block diagram illustrating part of the functional configuration of the wearable terminal 10.

A control unit 40 performs various controls on the wearable terminal 10, and is implemented by the CPU 21 that performs arithmetic processing. The control unit 40 of the present embodiment includes a communication processing unit 41, an input processing unit 42, a position information acquisition unit 43, a biometric information acquisition unit 44, a body movement information acquisition unit 45, an output value acquisition unit 46, a wearing state determination unit 47, an output processing unit 48, and a criterion setting unit 49.

The communication processing unit 41 performs processing for exchanging various pieces of information with a network such as the Internet via the communication unit 27, and performs processing for exchanging various pieces of information with the user terminal via the near field communication unit 36. For example, the communication processing unit 41 may transmit the biometric information detected by the biometric sensor 29 to the user terminal.

The input processing unit 42 performs processing for receiving an operation inputted via the input unit 24 by the user. For example, the input processing unit 42 performs processing based on an operation on the buttons performed by the user or an input by the user to the touch panel provided to the display 251.

The position information acquisition unit 43 performs processing for acquiring position information indicating the current position of the wearable terminal 10, based on a positioning signal detected by the GNSS unit 28.

The biometric information acquisition unit 44 performs processing for acquiring biometric information such as a pulse rate of the user, based on signals received by the biometric sensor 29.

The body movement information acquisition unit 45 performs processing for acquiring body movement information of the user wearing the wearable terminal 10, based on signals detected by the acceleration sensor 31.

The output value acquisition unit 46 performs processing for acquiring (sampling) an output value from the proximity sensor 32 at a predetermined sampling frequency (e.g., 32 Hz).

The wearing state determination unit 47 derives amplitude parameters representing amplitudes of output values (output waveforms) that have been outputted from the proximity sensor 32 and acquired by the output value acquisition unit 46 within a preset determination period. The determination period is set in advance to a length (e.g., 10 seconds) by way of an experiment, for example. A timing at which the determination period starts is set in accordance with, for example, a timing at which the biometric information acquisition unit 44 has started the operation for acquiring the biometric information. For example, the wearing state determination unit 47 may start the determination period at substantially the same timing as the timing at which the operation for acquiring the biometric information has been started. The determination period may be set differently depending on the magnitudes of body movements of the user, or may be set to a fixed period irrespective of the magnitudes of the body movements. For example, as the amplitude parameter, the difference between a maximum value and a minimum value that are adjacent to each other on the time axis included in the acquired output value (output waveform) is derived (calculated). Alternatively, any of the following values (a) to (e) may be derived (calculated) as the amplitude parameter.

(a) Absolute value of the difference between the minimum value and the maximum value;
(b) The difference between the maximum value and ½ of the sum of the maximum value and the minimum value ((maximal value+minimum value)/2);
(c) The absolute value of the difference between the minimum value and ½ of the sum of the maximum value and the minimum value;
(d) The difference between the maximum value and the median value of a plurality of extreme values (maximum values and minimum values) of the output values (the output waveforms) in the determination period; or
(e) The absolute value of the difference between the minimum value and the median value of the plurality of extreme values (maximum values and minimum values) of the output values (the output waveforms) in the determination period.

The wearing state determination unit 47 counts the number of amplitude parameters that are larger than a criterial value, among the derived amplitude parameters each representing a respective one of a plurality of amplitudes generated at different timings, the number being defined as an amplitude count for determination, and determines whether or not the wearable terminal 10 is properly worn on the wrist of the user based on the amplitude count for determination. Specifically, when the amplitude count for determination is larger than the criterial number, the wearing state determination unit 47 determines that the wearable terminal 10 is not properly worn on the wrist of the user. On the other hand, when the amplitude count for determination is equal to or less than the criterial number, the wearing state determination unit 47 determines that the wearable terminal 10 is properly worn on the wrist of the user. As can be seen, the wearing state is determined based on fluctuations of the output values (output waveforms) within the predetermined determination period, thereby making it possible to suitably determine whether the wearable terminal 10 is in a proper or improper wearing state (whether it is worn loosely), while changes in the wearing position of the wearable terminal 10 caused by the body movements of the user are reflected. The wearing state determination unit 47 may repeat the wearing state determination process described above until the operation for acquiring the biometric information is stopped. In this case, following the end of one determination period, the wearing state determination unit 47 may continuously start the next wearing state determination process, or may start the next wearing state determination process upon the lapse of a predetermined time interval.

When determining that the wearable terminal 10 is not properly worn on the body of the user, the wearing state determination unit 47 may cause the biometric information acquisition unit 44 to stop the operation for acquiring the biometric information. At this time, the wearing state determination unit 47 may perform processing for erasing, from the RAM 23 and/or the storage unit 26, the biometric information that has been acquired by the biometric information acquisition unit 44 and stored in the RAM 23 and/or the storage unit 26 prior to the stop of the operation for acquiring the biometric information.

The output processing unit 48 performs, for example, processing for causing the output unit 25 of the wearable terminal 10 to display an image, to generate vibration, and/or emit sound. For example, the output processing unit 48 performs processing for displaying information acquired from the user terminal, processing for displaying information acquired by the biometric information acquisition unit 44, processing for displaying information acquired by the body movement information acquisition unit 45, and processing for displaying results of determination by the wearing state determination unit 47. Further, for example, when the wearing state determination unit 47 determines that the wearable terminal 10 is not properly worn, the output processing unit 48 outputs information for prompting the user to check the wearing state. Specifically, when it is determined that the wearable terminal 10 is not properly worn, the output processing unit 48 causes the output unit 25 to display or generate at least one of an image, vibration, or sound for prompting the user to check the wearing state.

The criterion setting unit 49 sets, based on the body movement information acquired by the body movement information acquisition unit 45, a criterion or criteria with reference to which the wearing state determination unit 47 determines the wearing state. For example, the criterion setting unit 49 may set the criterial value and the criterial number described above, based on the body movement information. More specifically, for example, the criterion setting unit 49 may set the criterial value, which is related to the magnitude of the amplitude parameter, to a larger value as the body movement of the user becomes larger, and may set the criterial value to a smaller value as the body movement of the user becomes smaller. That is, the criterion setting unit 49 may set the criterial value such that the criterial value increases continuously (linearly/nonlinearly) or in a stepwise manner as the body movement of the user becomes larger. In this way, the wearing state can be determined in consideration of a degree of likelihood of change in the wearing position that is caused by the body movement of the user. The criterion setting unit 49 may set the criterial number based on, for example, the length of the determination period described above. More specifically, for example, the criterion setting unit 49 may set the criterial number to a smaller number as the body movement becomes smaller, and set the criterial number to a smaller number with a decrease in the length of the determination period.

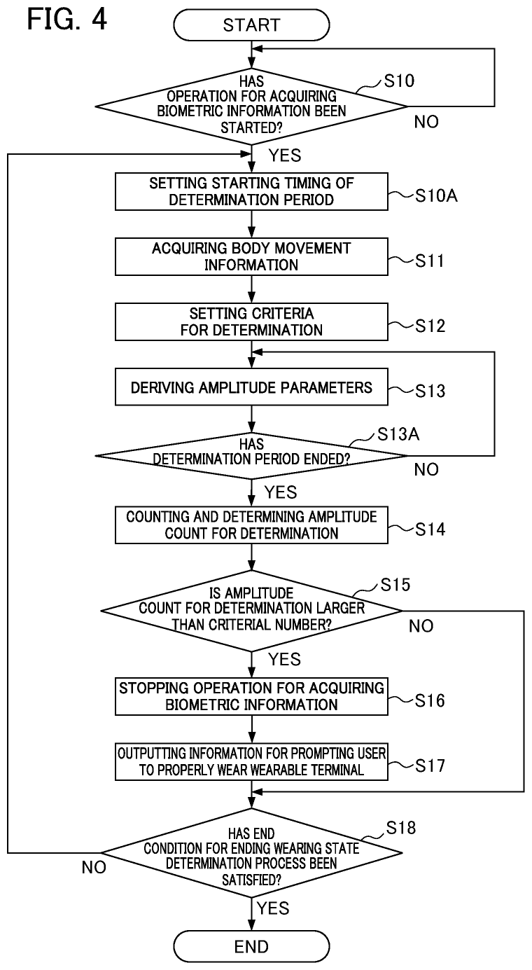

Example of Wearing State Determination Process Next, an example of the wearing state determination process performed by the control unit 40 of the wearable terminal 10 will be described with reference to FIG. 4. FIG. 4 is a flowchart illustrating an example of the flow of the wearing state determination process performed by the control unit 40 of the wearable terminal 10. For example, the control unit 40 starts the wearing state determination process at a timing when the control unit 40 receives an operation signal for starting the operation for acquiring the biometric information, inputted by the user.

In Step S10, the wearing state determination unit 47 determines whether or not the biometric information acquisition unit 44 has started the operation for acquiring the biometric information. Upon determining that the operation for acquiring the biometric information has been started (YES in Step S10), the wearing state determination unit 47 sets the starting timing of a determination period (Step S10A), and proceeds to Step S11. In a case where the current determination period is to be started immediately after the start of the operation for acquiring the biometric information determined by the wearing state determination unit 47 in Step S10, the starting timing of the current determination period is set to that timing of the start of the operation for acquiring the biometric information. Alternatively, in a case where a time delay of the proximity sensor 32 or the like is taken into consideration, the starting timing of the current determination period is set to a timing when a certain time (e.g., 1.0 sec) has elapsed from the timing set above. In a case where the current determination period is not one directly following the start of the operation for acquiring the biometric information, and it is determined that a previous determination period has ended in Step S13A to be described later, the starting timing of the determination period is set to a timing immediately after the end of the previous determination period. On the other hand, when the wearing state determination unit 47 determines that the operation for acquiring the biometric information has not been started (NO in Step S10), the wearing state determination unit 47 repeats the processing of Step S10.

In Step S11, the body movement information acquisition unit 45 acquires, from signals detected by the acceleration sensor 31, body movement information regarding the user, that is, movement information of the wrist of the user on which the wearable terminal 10 is worn.

In Step S12, based on the body movement information acquired in Step S11, the criterion setting unit 49 sets criteria (a criterial value and a period for determining the criterial number) for the wearing state determination unit 47 to determine the wearing state, as described above.

In Step S13, the wearing state determination unit 47 derives amplitude parameters representing the amplitudes of the output values (output waveforms) from the proximity sensor 32. Specifically, for example, the wearing state determination unit 47 derives the amplitude parameters of the output values (output waveforms) as the difference between the maximum value and the minimum value of the output values (output waveforms) from the proximity sensor 32 acquired by the output value acquisition unit 46 within a preset determination period. The wearing state determination unit 47 derives the amplitude parameters from output values (output waveforms) generated at a plurality of different timings in the determination period.

In Step 13A, the wearing state determination unit 47 determines whether or not the determination period has ended, that is, whether or not a time corresponding to the determination period has elapsed from the starting timing of the determination period set in Step S10A. If the determination period has not ended, the wearing state determination unit 47 returns to Step S13 of the process, whereas when the determination period has ended, the process proceeds to Step S14.

In Step S14, the wearing state determination unit 47 counts the number of amplitude parameters that are larger than the criterial value set in Step S12, among the amplitude parameters derived in Step S13 and each representing a respective one of a plurality of amplitudes generated at different timings, and the number of amplitude parameters is defined as an amplitude count for determination.

In Step S15, the wearing state determination unit 47 determines whether or not the wearable terminal 10 is properly worn on the wrist of the user based on the amplitude count for determination, which has been determined in Step S14. Specifically, when the amplitude count for determination determined in Step S14 is equal to or less than the criterial number set in Step S12 (NO in Step S15), the wearing state determination unit 47 determines that the wearable terminal 10 is properly worn on the wrist of the user. Next, it is determined whether or not an end condition for ending the wearing state determination process has been satisfied (Step S18). The end condition is satisfied when the wearable terminal 10 is turned off or when the user performs an operation to end the operation for acquiring the biometric information. When the end condition for ending the wearing state determination process has been satisfied (Yes in Step S18), the process ends. When the end condition for ending the wearing state determination process has not been satisfied (No in Step S18), the process returns to Step S10A. On the other hand, when the amplitude count for determination determined in Step S14 is larger than the criterial number set in Step S12 (YES in step S15), the wearing state determination unit 47 determines that the wearable terminal 10 is not properly worn on the wrist of the user, and the process proceeds to Step S16. For example, an assumption is made here that the determination period is set to 10 seconds, the criterial value is set to 500, and the criterial number is set to four. In this case, when five or more amplitude parameters are larger than 500, among the amplitude parameters derived from the output values acquired from the proximity sensor 32 within 10 seconds, it is determined that the wearable terminal 10 is not properly worn on the user's body.

In Step S16, the biometric information acquisition unit 44 stops the operation for acquiring the biometric information.

In Step S17, the output processing unit 48 performs a processing for causing the output unit 25 to display an image or to generate sound or vibration so as to prompt the user to properly wear the main body 11. Step S18 and the subsequent steps are then performed.

As described above, according to the wearing state determination process, during the period from the start of the process for acquiring the biometric information to the satisfaction of the end condition for ending the wearing state determination process, the criterial are set every time the determination period ends (Steps S10A and S12), and the wearing state of the wearable terminal 10 is determined based on the amplitude count for determination determined in each determination period. After a determination is once made that the wearable terminal 10 is not properly worn (YES in Step S15), if it is determined that the wearable terminal 10 is properly worn (No in Step S15) through a subsequent determination operation, the process may be ended on the assumption that the end condition has been satisfied. In this case, the end condition may be deemed to be satisfied when the determination that the wearable terminal 10 is properly worn is successively made a plurality of times (e.g., three times).

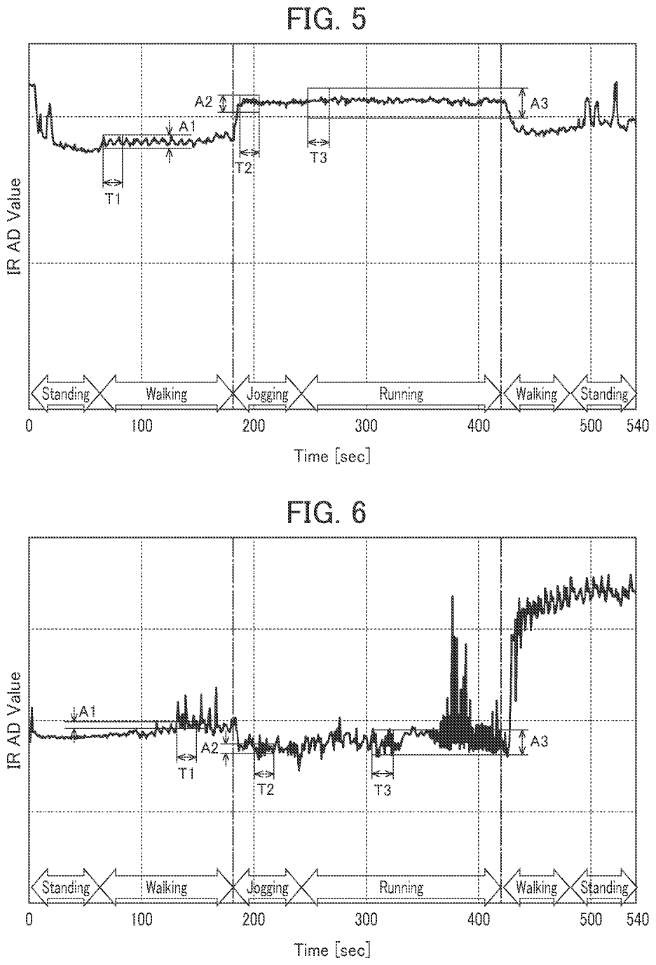

Next, effects that the wearing states of the wearable terminal 10 and the body movements of the user exert on the output values (output waveforms) from the proximity sensor 32 and the pulse wave information will be described with reference to FIGS. 5 to 10.

### Evaluation Test

An evaluation test was conducted to study the effects that the wearing states of a smart watch as the wearable terminal 10 and body movements exerted on the amplitude parameters (output waveform) from the proximity sensor 32 and the pulse wave information. The evaluation test was carried out using the wearable terminal 10, a chest belt provided with a pulse wave sensor, and a treadmill. As the proximity sensor 32, an infrared sensor was used which emitted an infrared ray to the skin of a user, detected reflected light of the infrared ray, and thereby outputted an output value corresponding to a position on the user's body at which the main body of the wearable terminal 10 was worn. The output values were obtained by sampling the output from the infrared sensor at 32 Hz as the sampling frequency and by subjecting the output to A/D conversion.

In the evaluation test, the user wearing the wearable terminal 10 on the wrist and having the chest belt tightly wrapped on the body so that the pulse wave sensor of the chest belt was positioned on the chest performed the following set of exercises on the running deck of the treadmill, whereby the output values (output waveforms) from the proximity sensor 32 and the pulse wave information were measured. The set of exercises using the treadmill included one-minute standing on the stopped running deck, two-minute walking on the running deck moving at a walking speed, one-minute jogging on the running deck moving at a jogging speed faster than the walking speed, three-minute running on the running deck moving at a running speed faster than the jogging speed, one-minute walking, and one-minute standing. The test was conducted on the precondition that the user periodically swung their arms (reciprocated the arms in the front-rear direction of the user) during all the walking, jogging, and running of the set of exercises. In the evaluation test, the output values (output waveforms) from the proximity sensor 32 and the pulse wave information were measured in different wearing states of the wearable terminal 10. In a first wearing state, the main body 11 and the band 12 of the wearable terminal 10 were tightly attached to be fully in contact with the user's wrist. In a second wearing state, the wearable terminal 10 was loosened to have slack corresponding to two adjustment holes 14, relative to the first wearing state. In a third wearing state, the wearable terminal 10 was further loosened to have more slack corresponding to one adjustment hole 14, relative to the second wearing state. For example, these wearing state can be explained as follows in the case of the wearable terminal 10 illustrated in FIG. 1. If a state in which the buckle tongue 132 is fitted to the adjustment hole 141 is defined as the first wearing state, the second wearing state corresponds to a state in which the buckle tongue 132 is fitted to the adjustment hole 143, and the third wearing state corresponds to a state in which the buckle tongue 132 is fitted to the adjustment hole 144. All the measurements were conducted while the wearing state of the chest belt remained unchanged.

### Results of Evaluation Test

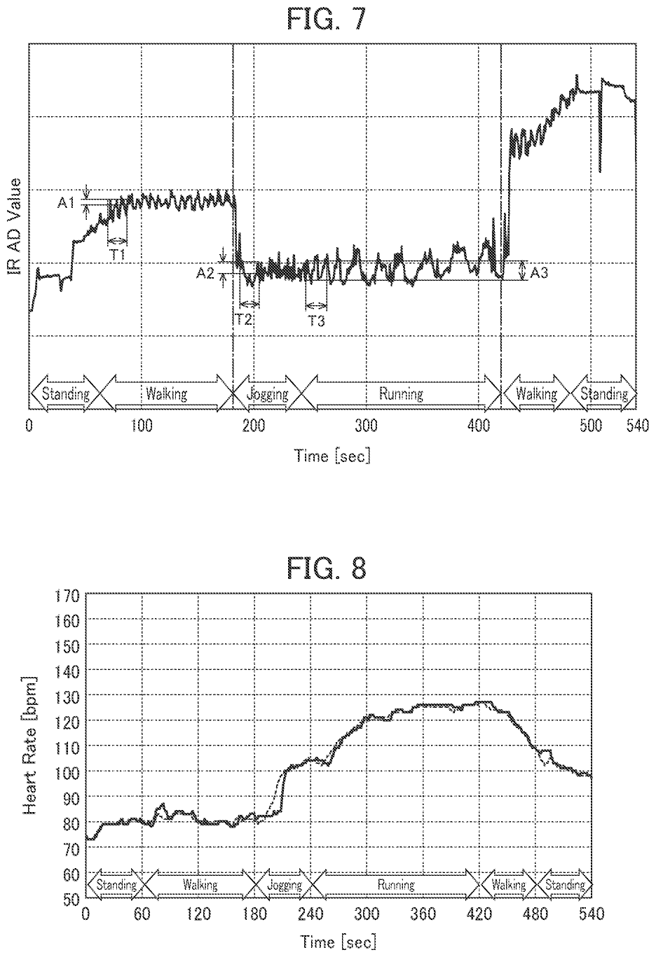

FIG. 5 is a graph showing the measurement results of the output values (output waveforms) from the infrared sensor as the proximity sensor 32 in the first wearing state, FIG. 6 is a graph showing the measurement results of the output values (output waveforms) from the infrared sensor in the second wearing state, and FIG. 7 is a graph showing the measurement results of the output values (output waveforms) from the infrared sensor in the third wearing state. In FIGS. 5 to 7, the horizontal axis represents time (“Time” where the unit is sec), and the vertical axis represents an output value (“IR AD value”) from the infrared sensor. The dash-dot lines indicate the start time of the jogging and the end time of the running. FIGS. 5 to 7 illustrate, as examples, magnitudes A1 to A3 of the criterial values as criteria set by the criterion setting unit 49 for the determination of the wearing state of the wearable terminal 10 according to the present embodiment, and lengths T1 to T3 of the preset determination periods. Specifically, A1 denotes the magnitude of the criterial value set for the time of walking, A2 denotes the magnitude of the criterial value set for the time of jogging, and A3 denotes the magnitude of the criterial value set for the time of running. T1 denotes the length of the determination period set in the time of walking, T2 denotes the length of the determination period set in the time of jogging, and T3 denotes the length of the determination period set in the time of running. As illustrated in FIGS. 5 to 7, the criterial values were set to increase as the body movement of the user became larger. Since the vertical axes in FIGS. 5 to 7 are at different scales, the same criterial value appears to have different magnitudes from one figure to another, but the same criterial value has the same magnitude.

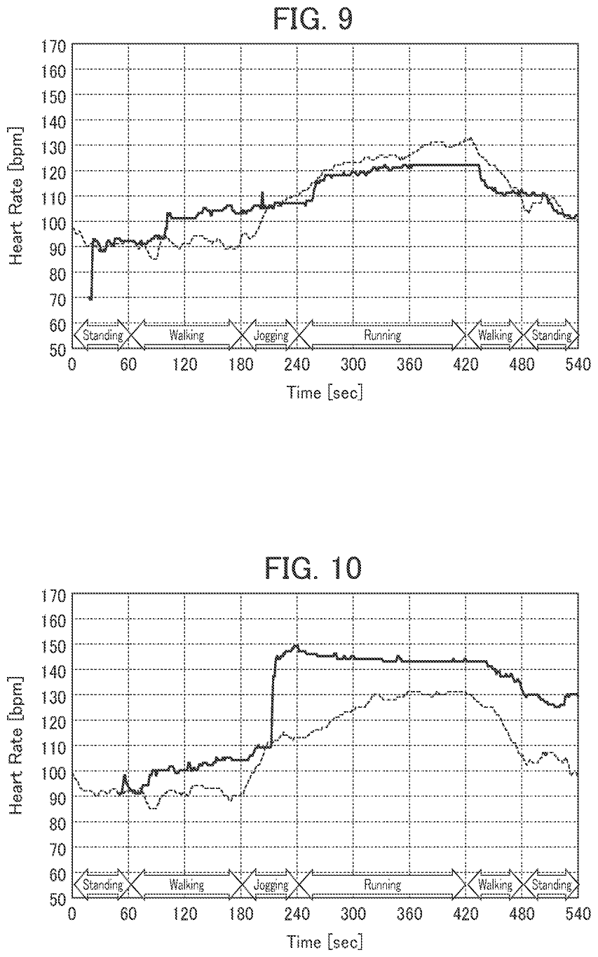

FIG. 8 is a graph showing a pulse rate derived by the CPU 21 based on the pulse wave measured by the biometric sensor 29 when the wearable terminal 10 was in the first wearing state, FIG. 9 is a graph showing a pulse rate derived by the CPU 21 based on the pulse wave measured by the biometric sensor 29 when the wearable terminal 10 was in the second wearing state, and FIG. 10 is graph showing a pulse rate derived by the CPU 21 based on the pulse wave measured by the biometric sensor 29 when the wearable terminal 10 was in the third wearing state. In FIGS. 8 to 10, the horizontal axis represents time (sec), and the vertical axis represents the pulse rate (bpm). The solid line indicates the pulse rate derived by the CPU 21 of the wearable terminal 10 in the respective wearing state, and the broken line indicates the pulse rate measured by the chest belt. FIGS. 9 and 10 show the pulse rate that was derived regardless of the determination result of the wearing state of the wearable terminal 10 (the determination result in Step S15).

As illustrated in FIG. 5, in the first wearing state, the amplitudes of the output values from the infrared sensor were maintained at small levels throughout the entire set of exercises (including standing, walking, jogging, running, walking, and standing in this order), and the amplitude parameters were smaller than the criterial values A1, A2, and A3 during the determination periods T1, T2, and T3. This is considered to be because in the first wearing state, the band 12 of the wearable terminal 10 tightly worn on the user's wrist contribute to a decrease in change in the wearing position of the main body 11 that could be caused by the body movements of the user, i.e., the swinging movements of the user's arm. As illustrated in FIG. 8, although the pulse rate based on the pulse wave detected by the biometric sensor 29 of the wearable terminal 10 was slightly different from the pulse rate detected by the chest belt during the jogging, the mean absolute error (MEA) calculated from the average of the pulse rate differences between the pulse rate detected by the wearable terminal 10 and that detected by the chest belt throughout the entire set of exercises was maintained at a low level. Specifically, the MEA was 1.182.

As illustrated in FIG. 6, in the second wearing state, the amplitudes of the output values (output waveforms) from the infrared sensor were maintained at low levels during the standing where the user's arm made little movement and at the time of the start of the walking when the user's arm made relatively small swinging movements. On the other hand, during the walking, the amplitudes of the output values (output waveforms) gradually increased with the passage of time. Further, at the time from about 1 minute to about 2 minutes following the start of the walking, and during the jogging and the running when the use's arm made relatively large and fast swinging movements, the output values (output waveforms) increased and decreased (oscillated) within a range of about 500, and the amplitudes of the output values (output waveforms) increased to reach relatively large value to exceed the criterial values A1, A2, and A3. As illustrated in FIG. 9, the difference between the pulse rate detected by the wearable terminal 10 and the pulse rate detected by the chest belt was small during the standing and at the time of the start of the walking. On the other hand, the difference between the pulse rate detected by the wearable terminal 10 and the pulse rate detected by the chest belt was large at the time from about 1 minute to about 2 minutes following the start of walking and during the jogging and the running, when the amplitudes of the output values (output waveforms) were relatively large. The MEA in the second wearing state was 5.674. From FIGS. 6 and 9, it can be confirmed that the amplitudes of the output values (output waveforms) from the infrared sensor increases as the body movements become larger, and the measurement accuracy of the pulse rate decreases as the amplitudes of the output values (output waveforms) from the infrared sensor increase.

As illustrated in FIG. 7, in the third wearing state, the amplitudes of the output values (output waveforms) from the infrared sensor were particularly large during the jogging and the running, and the amplitudes of the output values (output waveforms) were not maintained at small levels even during the walking. As illustrated in FIG. 10, the difference between the pulse rate detected by the wearable terminal 10 and the pulse rate detected by the chest belt was larger than in the second wearing state. The MEA was 16.692, from which it can be confirmed that the pulse rate was not accurately measured.

From the results of the evaluation test, it can be confirmed that, when the band 12 of the wearable terminal 10 is loosely worn on the wrist, as the degree of change in the wearing position of the wearable terminal 10 caused by the user's body movements (swinging movements of the user's arm) become larger, the amplitudes of the output values (output waveforms) from the infrared sensor become larger, and a plurality of such relatively large amplitudes are generated. It also can be confirmed that the measurement error of the pulse rate tends to increase when the amplitudes of the output values (output waveforms) from the infrared sensor increase.

As described above, the wearable terminal 10 of the present embodiment includes the control unit 40 that acquires output values (output waveforms) from the proximity sensor 32 worn adjacent to the body of a user via the wearable terminal 10, derives amplitude parameters representing amplitudes of the output values (output waveforms) acquired within a preset determination period, counts the number of amplitude parameters that are larger than a criterial value, among the derived amplitude parameters each representing a respective one of a plurality of amplitudes generated at different timings, the number being defined as an amplitude count for determination, and determines whether the wearable terminal 10 is properly worn on the wrist of the user based on the amplitude count for determination.

Due to this feature, the wearing state is determined based on fluctuations of the output values (output waveforms) within the predetermined determination period, so that the movement of the main body 11 with respect to the body of the user can be more sensitively detected for the determination of the wearing state. Therefore, even when the user is moving his/her body, it is possible to suitably determine whether or not the wearable terminal 10 is properly worn on the user's body.

In the wearable terminal 10 according to the present embodiment, the control unit 40 determines that the wearable terminal 10 is not properly worn on the user's body when the amplitude count for determination is larger than the criterial number.

Thus, the simple processing of counting the number of amplitude parameters larger than the criterial value within a predetermined determination period makes it possible to specify a case where the wearable terminal 10 is not properly worn on the user's body.

In the wearable terminal 10 according to the present embodiment, the control unit 40 acquires the body movement information of the user, and sets the criterial value based on the acquired body movement information.

This feature in which the criterion for determining the wearing state is set in accordance with the body movement information enables determination on whether or not the wearable terminal 10 is properly worn on the user's body to be made in consideration of the magnitude of a body movement. For example, setting the criterial value related to the magnitude of the amplitude parameter such that the criterial value become higher as the body movement become larger makes it possible to avoid excessive tightening of the band 12 or the like of the wearable terminal 10 in consideration of likelihood of change in the wearing position of the wearable terminal 10 that can be caused by a large body movement. On the contrary, in a case where a body movement is small and less likely to change the wearing position of the wearable terminal 10, the amplitude of a smaller output value (output waveform) can be set as the criterial value for determination. Thus, even when the body movement is small, an improper wearing state can be more reliably determined. Therefore, the wearing state of the wearable terminal 10 can be re-checked in advance, before a strenuous exercise such as running is started.

In the wearable terminal 10 according to the present embodiment, the control unit 40 acquires the biometric information of the user, and the starting timing of the determination period is set in accordance with the timing at which the operation for acquiring the biometric information has been started.

Thus, since the wearing state of the wearable terminal 10 can be determined in accordance with the timing at which the operation for acquiring the biometric information has been started, accurate pulse wave information can be acquired in a proper wearing state.

In the wearable terminal 10 according to the present embodiment, upon determining that the wearable terminal 10 is not properly worn on the user's body, the control unit 40 stops the operation for acquiring the biometric information.

This feature makes it possible to avoid acquisition of inaccurate biometric information that can be measured when the wearable terminal 10 is not properly worn on the user's body.

In the wearable terminal 10 according to the present embodiment, upon determining that the wearable terminal 10 is not properly worn on the user's body, the control unit 40 outputs information for prompting the user to re-check the wearing state of the wearable terminal 10.

This feature makes it possible to promptly notify the user that the wearable terminal 10 is not properly worn.

It should be noted that the present invention is not limited to the above-described embodiments, and modifications, improvements, and the like within a range where the object of the present invention can be achieved are encompassed in the present invention.

In the above-described embodiment, the criterion setting unit 49 sets, based on the body movements, the criteria such as the criterial value related to the magnitudes of the amplitude parameters representing the amplitudes of the output values (output waveforms) from the proximity sensor 32, but a criterion may be set based on illuminance information of external light. For example, the criterion setting unit 49 may acquire the illuminance information of external light incident on the proximity sensor 32 and set a criterial value based on the acquired illuminance information. More specifically, the criterion setting unit 49 may set the criterial value related to the magnitudes of the amplitude parameters such that the criterial value becomes smaller with a decrease in the illuminance and becomes larger with an increase in the illuminance. Due to this feature, the wearing state of the wearable terminal 10 is determined in consideration of the illuminance of external light affecting the output of the proximity sensor 32, making it possible to determine whether or not the wearable terminal 10 is properly worn on the user's body with higher accuracy.

In the above-described embodiment, the wearable terminal 10 includes the criterion setting unit 49, which sets the criteria for determining the wearing state based on the body movement information. However, the criterion setting unit 49 may be omitted, and a fixed value may be preset and used as the criterion for determining the wearing state.

The above-described embodiment includes the biometric sensor 29 for detecting the biometric information of the user and the biometric information acquisition unit 44 for acquiring the biometric information. However, the biometric sensor 29 and the biometric information acquisition unit 44 may be omitted.

In the above-described embodiment, upon determining that the wearable terminal 10 is not properly worn on the user's body, the control unit 40 causes the biometric information acquisition unit 44 to stop the operation for acquiring the biometric information. The control unit 40 may additionally cause the biometric sensor 29 to stop the operation for detecting the biometric information acquisition.

In the above-described embodiment, the wearable terminal 10 is configured as an information processing apparatus including the control unit 40 that determines the wearing state of the wearable terminal 10 itself worn on the user's body. However, the CPU 21 included in the wearable terminal 10 may be configured as the information processing apparatus. Although the control unit 40 according to the above-described embodiment is constituted by one CPU 21, the control unit 40 may be constituted by a plurality of CPUs and configured such that each of the functions of the control unit 40 is individually performed by a respective one of the CPUs.

In the above-described embodiment, the biometric sensor 29 detects the pulse wave information of the user and the biometric information acquisition unit 44 acquires (derives) the pulse rate of the user. However, the biometric information of the user detected by the biometric sensor 29 and acquired by the biometric information acquisition unit 44 is not particularly limited. For example, a blood flow or a blood pressure of the user may be detected as the biometric information.

In the above-described embodiment, the wearing state of the main body 11 is determined at the wearable terminal 10's end. However, the user terminal may acquire (derive) amplitude parameters representing the amplitudes of output values (output waveforms) from the proximity sensor 32 to determine the wearing state of the main body 11 of the wearable terminal 10.

In the above-described embodiment, the criteria for determining the wearable state of the main body 11 is set at the wearable terminal 10's end. However, the user terminal may acquire the body movement information of the user and set the criteria for determining the wearable state of the wearable terminal 10.

In the above-described embodiment, the wearable terminal 10 is a smart watch wearable on the wrist of the user. However, the wearable terminal 10 does not have to be a device wearable on the wrist, but may be a device wearable on another appropriate site such as an arm, an ankle, a shoe, a leg, a waist, a chest, or a head.

In the above-described embodiment, exercises involving periodic swinging movements of the user's arms, such as walking, jogging, and running, have been described as examples relating to body movements, but the exercises are not limited to any particular types. For example, the body movement may be of trekking, swimming, ball games, yoga, fitness, gymnastics, or the like.

In the above-described embodiment, the proximity sensor 32 of the wearable terminal 10 is configured as an infrared sensor, but it may be a capacitance type sensor. In that case, the control unit 40 may derive amplitude parameters representing amplitudes of output values (output waveforms) from the capacitance type sensor acquired within a preset determination period, count the number of amplitude parameters that are larger than a criterial value, among the derived amplitude parameters each representing a respective one of a plurality of amplitudes generated at different timings, the number being defined as an amplitude count for determination, and determine whether the wearable apparatus is properly worn on the body of a user based on the amplitude count for determination.

The series of processes described above may be executed by hardware or software. In other words, the functional configurations described in the above embodiments and modifications are merely illustrative and are not particularly limited. That is, it is only necessary for the wearable terminal 10 to have a function of executing the above-described series of processes as a whole, and functional blocks to be employed to enable this function are not particularly limited to those of the above-described embodiments and modifications. One functional block may be constituted by a single piece of hardware, a single piece of software, or a combination thereof.

The hardware configurations described in the above embodiments and modifications are mere examples, and the present invention is not limited to these configurations. Processors that can be used in the present embodiment include various types of processing units such as a single processor, a multiprocessor, a multicore processor, and a combination of such a processing unit and a processing circuit such as an application specific integrated circuit (ASIC) or a field-programmable gate array (FPGA).

When the series of processes is to be executed by software, a program constituting the software is installed in a computer or the like from a network or a recording medium. The computer may be a computer incorporated in dedicated hardware. The computer may be a computer capable of performing various functions by installing various programs. For example, the computer may be a general-purpose personal computer.

In the present specification, steps of describing programs to be recorded in the recording medium include not only processes that are performed in time series in a predetermined order, but also processes that do not necessarily have to be performed in time series and may be performed in parallel or individually.

While embodiments of the present invention have been described, the above embodiments have been presented by way of example only, and are not intended to limit the scope of the present invention. The present invention can be implemented in various other embodiments, and various changes such as omission and substitution can be made without departing from the spirit of the present invention. The embodiments and modifications thereof are included in the scope and spirit of the invention disclosed in the present specification and accompanying documents, and are encompassed in the invention defined in the claims and equivalents of the invention.

What is claimed:

1. An information processing apparatus comprising:
a processor,
the processor that periodically acquires output values from a sensor in a state where the sensor is worn adjacent to a body of a user via a wearable device,
derives amplitude parameters representing amplitudes of a plurality of output values among the output values acquired from the sensor, the plurality of output values having been acquired at a plurality of different timings within a preset determination period,
counts a number of amplitude parameters that are larger than a criterial value, among the derived amplitude parameters each representing a respective one of a plurality of amplitudes generated at different timings, the number being defined as an amplitude count for determination, and
determines whether the wearable device is properly worn on the body of the user based on the amplitude count for determination.

2. The information processing apparatus according to claim 1,
wherein the processor determines that the wearable device is not properly worn on the body of the user in a case where the amplitude count for determination is larger than a criterial number.

3. The information processing apparatus according to claim 1,
wherein the processor acquires body movement information of the user, and sets the criterial value based on the acquired body movement information.

4. The information processing apparatus according to claim 1,
wherein the processor acquires illuminance information of external light incident on the sensor, and sets the criterial value based on the acquired illuminance information.

5. The information processing apparatus according to claim 1,
wherein the processor acquires biometric information of the user, and
wherein a starting timing of the preset determination period is set in accordance with a timing at which an operation for acquiring the biometric information has been started.

6. The information processing apparatus according to claim 5,
wherein upon determining that the wearable device is not properly worn on the body of the user, the processor stops the operation for acquiring the biometric information.

7. The information processing apparatus according to claim 1,
wherein upon determining that the wearable device is not properly worn on the body of the user, the processor outputs information for prompting the user to check a wearing state of the wearable device.

8. The information processing apparatus according to claim 1,
wherein the sensor is an optical sensor, and
wherein the output values are results of measurement of reflected light received by a light receiver of the optical sensor, the reflected light having originated from light emitted from the optical sensor and having been reflected from the body of the user.

9. A non-transitory computer-readable storage medium storing a program that is executable by a computer including a processor to control an information processing apparatus, the program being executable to cause the computer to perform operations comprising:
periodically acquiring output values from a sensor in a state where the sensor is worn adjacent to a body of a user via a wearable device;
deriving amplitude parameters representing amplitudes of a plurality of output values among the output values acquired from the sensor, the plurality of output values having been acquired at a plurality of different timings within a preset determination period;
counting a number of amplitude parameters that are larger than a criterial value, among the derived amplitude parameters each representing a respective one of a plurality of amplitudes generated at different timings, the number being defined as an amplitude count for determination, and
determining whether the wearable device is properly worn on the body of the user based on the amplitude count for determination.

10. A method of determining a wearing state, the method being executable by a processor of an information processing apparatus and comprising:
periodically acquiring output values from a sensor in a state where the sensor is worn adjacent to a body of a user via a wearable device;
deriving amplitude parameters representing amplitudes of a plurality of output values among the output values acquired from the sensor, the plurality of output values having been acquired at a plurality of different timings within a preset determination period;
counting a number of amplitude parameters that are larger than a criterial value, among the derived amplitude parameters each representing a respective one of a plurality of amplitudes generated at different timings, and the number being defined as an amplitude count for determination; and
determining whether the wearable device is properly worn on the body of the user based on the amplitude count for determination.

11. The method according to claim 10,
wherein the processor determines that the wearable device is not properly worn on the body of the user in a case where the amplitude count for determination is larger than a criterial number.

12. The method according to claim 10,
wherein the processor acquires body movement information of the user, and sets the criterial value based on the acquired body movement information.

13. The method according to claim 10,
wherein the processor acquires illuminance information of external light incident on the sensor, and sets the criterial value based on the acquired illuminance information.

14. The method according to claim 10,
wherein the processor acquires biometric information of the user, and
wherein a starting timing of the preset determination period is set in accordance with a timing at which an operation for acquiring the biometric information has been started.

15. The method according to claim 14,
wherein upon determining that the wearable device is not properly worn on the body of the user, the processor stops the operation for acquiring the biometric information.

16. The method according to claim 10,
wherein upon determining that the wearable device is not properly worn on the body of the user, the processor outputs information for prompting the user to check a wearing state of the wearable device.

17. The method according to claim 10,
wherein the sensor is an optical sensor, and
wherein the output values are results of measurement of reflected light received by a light receiver of the optical sensor, the reflected light having originated from light emitted from the optical sensor and having been reflected from the body of the user.
